(19) United States
(12) Patent Application Publication
(10) Pub. No.: US 2017/0368977 A1
(43) Pub. Date: Dec. 28, 2017

(54) CUP HOLDER RELEASABLY MOUNTABLE ON AN ARMREST OF A VEHICLE

(71) Applicant: Ford Global Technologies, LLC, Dearborn, MI (US)

(72) Inventors: Arda Arpinar, Istanbul (TR); Semih Kasab, Adapazari (TR); Murat Kaynar, Golcuk (TR)

(21) Appl. No.: 15/632,543

(22) Filed: Jun. 26, 2017

(30) Foreign Application Priority Data
Jun. 27, 2016 (EP) 16176314.9

(51) Int. Cl. B60N 3/10; B60N 2/46; A47C 7/70

(52) U.S. Cl. CPC B60N 3/103; B60N 3/102; A47C 7/70; B60N 2/4606; B60N 2/4686

(57) ABSTRACT

The present disclosure relates to a cup holder releasably mountable to an armrest of a vehicle. The cup holder comprises an end portion having a shape for holding a cup or bottle or beverage container, and an elongated tubular portion having a first end connected to the end portion and a second end, comprising an opening for receiving at least part of the armrest, and a clamping assembly for releasably clamping the armrest when inserted in the opening, without damaging the armrest.

### FIELD OF THE INVENTION

The present invention generally relates to a cup holder for holding a cup or bottle or other kind of beverage container in a vehicle, and in particular, relates to a cup holder which is releasably mountable in a vehicle such as a wheeled car or a van or the like.

### BACKGROUND OF THE INVENTION

Cup holders have become a highly desired feature for the interior systems for not only passenger cars but also commercial vehicles. Nowadays, in some vehicles, the cup holders are placed into sides of the dashboard, as there typically is insufficient space at the center of the dashboard to put a cup holder, especially for the dual passenger seated commercial vehicles like VAN vehicles. An example of an existing cup holder is shown in FIG. 2, where the dashboard has an integrated left cup holder 4a and an integrated right cup holder 4b.

A problem of such cup holders or the beverage container put therein, is that the latter may obstruct the view in the side mirror. It would be desirable to provide a cup holder which does not prevent good sight of the driver and which can be readily installed and removed when desired.

### SUMMARY OF THE INVENTION

According to one embodiment, a cup holder releasably mountable to an armrest of a vehicle is provided. The cup holder includes an end portion having a shape configured to hold a cup, and an elongated tubular portion having a first end connected to the end portion and a second end, opposite the first end, comprising an opening for receiving at least part of the armrest. The cup holder also includes a clamping assembly formed in the tubular portion for releasably clamping the armrest when inserted in the opening, without damaging the armrest.

According to another aspect of the invention, a cup holder releasably mountable to an armrest of a vehicle is provided. The cup holder includes an end portion having a shape configured to hold a cup, and an elongated tubular portion having a first end connected to the end portion and an opposite second end comprising an opening for receiving at least part of the armrest. The cup holder also includes a clamping assembly for releasably clamping the armrest when inserted in the opening.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a 3D top perspective view of the front seats of a vehicle, where a cup holder is mounted to the armrest located on the right of the driver seat, according to one embodiment;

FIG. 2 is a top view of the vehicle of FIG. 1, also showing existing cup holders built-in on the left side and right side of the dashboard;

FIG. 3 is a 3D side elevated perspective view of the vehicle of FIG. 1;

FIG. 4 is a side view of the vehicle of FIG. 3;

FIG. 5 is a side view of an exemplary embodiment of a cup holder, as seen from the outside; the cup holder has an elongated tubular portion (right of the figure), and an end portion for holding a cup (left of the figure);

FIG. 6 is a top view of the cup holder shown in FIG. 5;

FIG. 7 is a cross-sectional view showing the cup holder taken through line VII of FIG. 5 with a flexible material arranged inside an inner wall of the tubular portion, wherein the flexible material may have a corrugated shape, and may be a foamed material;

FIG. 8 is a rear view of the cup holder of FIG. 5 (looking inside the elongated tubular portion);

FIG. 9 is a variant of the embodiment of FIG. 7, comprising at least one movable element, e.g. a movable plate, operated by a spring, for clamping the armrest to the upper wall of the cup holder;

FIG. 10 is another variant of the embodiment of FIG. 7, comprising at least one movable element, e.g., two movable plates, each movable by means of a bolt, for clamping the armrest to the upper wall of the cup holder;

FIG. 11 is a side view showing an embodiment of a cup holder without a cup, where the end portion has a truncated cone shape, and contains a movable element and a spring for holding or clamping the cup, and wherein the movable element extends in the space defined by the truncated cone;

FIG. 12 is a side view showing an embodiment of a cup holder containing a cup, where the end portion has a truncated cone shape, and contains a movable element and a spring for holding or clamping the cup or bottle or beverage container, and the means is substantially flush with the inner wall of the truncated cone surface;

FIG. 13 shows the cup holder mounted to an armrest of a vehicle, wherein the driver's arm is located next to the cup holder, and no cup or bottle or container is present in the cup holder;

FIG. 14 shows the cup holder mounted to an armrest of a vehicle, wherein the driver is picking a bottle out of the end portion of the cup holder, in a very convenient manner, while driving with his left hand;

FIG. 15 shows the cup holder mounted to an armrest of a vehicle, wherein the driver is switching gear without being hindered by the bottle in the cup holder;

FIG. 16 shows the cup holder mounted to an armrest of a vehicle, wherein the driver's arm elbow is resting on the cup holder;

FIG. 17 shows the armrest in an upright position, with the cup holder still mounted thereon;

FIG. 18 shows the cup holder being stowed in the upper compartment of the right front door after being removed from the armrest;

FIG. 19 shows the cup holder being stowed in the lower compartment of the right front door after being removed from the armrest;

FIG. 20 shows the elongated tubular portion of the cup holder being inserted in an elongated cavity in the dashboard of the vehicle after being removed from the armrest; and

FIG. 21 shows the cup holder being inserted in the glove compartment of the dashboard of the vehicle after being removed from the armrest.

### DETAILED DESCRIPTION OF THE PREFERRED EMBODIMENTS

The present disclosure is related to a cup holder 1 for a vehicle, such as for use in a car or in a van. A problem of existing cup holders is: i) they may be located in a position blocking view of one side mirror or both side mirrors; ii) they are embedded in the dashboard of the car, thus are present only in particular car models; iii) the driver (of vehicles having the steering wheel on the left-hand side) needs to move his right hand over the driving wheel to reach the cup or beverage while driving with his left arm, which is not very convenient, and may even lead to dangerous situations. According to the present invention, an elegant and simple solution is provided which may solve all these problems.

The inventors surprisingly came to the idea of providing a cup holder 1 that can be releasably mounted to an armrest 2 of the vehicle, and thus is automatically positioned directly adjacent the driver, and more in particular, near the driver's arm. This offers the advantage that the driver only needs to make minimal movement with his arm to reach the beverage container or to put it back.

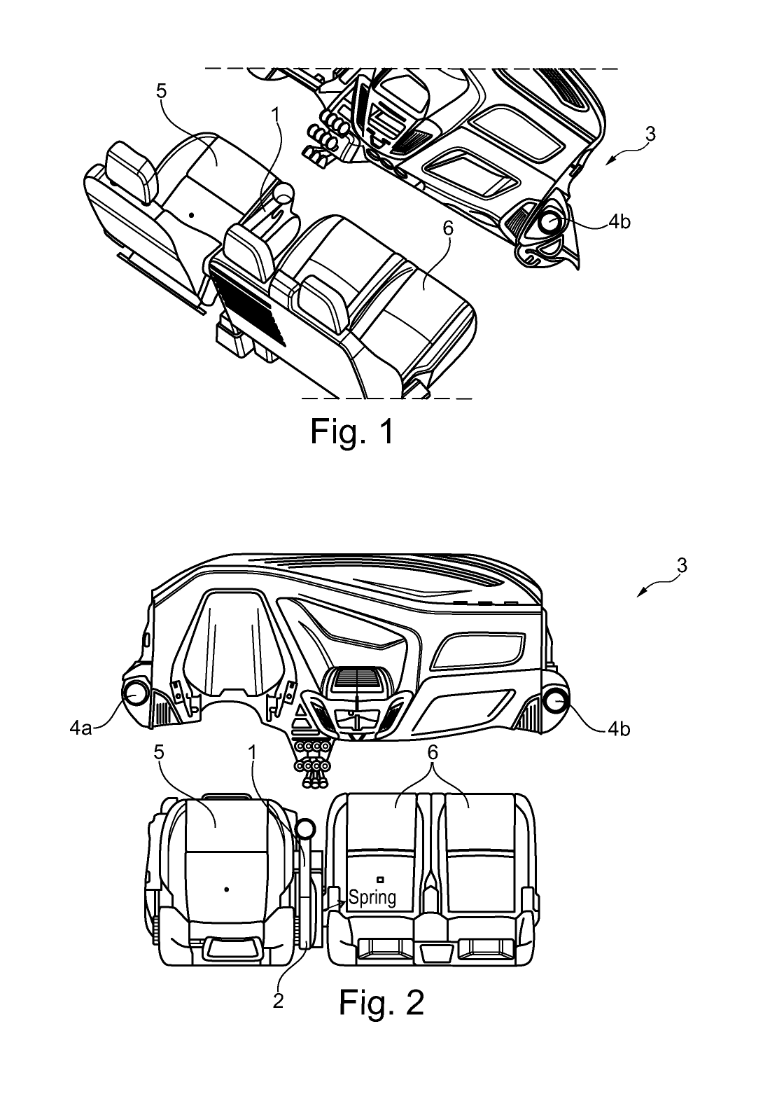

Referring to the figures, FIG. 1 shows a 3D top perspective view, and FIG. 2 shows a top view of a vehicle having a dashboard 3 with embedded cup holders 4a, 4b (state of the art) located respectively on the left extreme and right extreme side of the dashboard, near the side mirrors (not shown). The vehicle has the armrest 2 located between the driver's seat 5 and the passenger seats 6. Also shown is an embodiment of a cup holder 1. The cup holder 1 is slid on the armrest 2, and thereby located on the right of the driver's seat 5, for easy access by the driver (not shown).

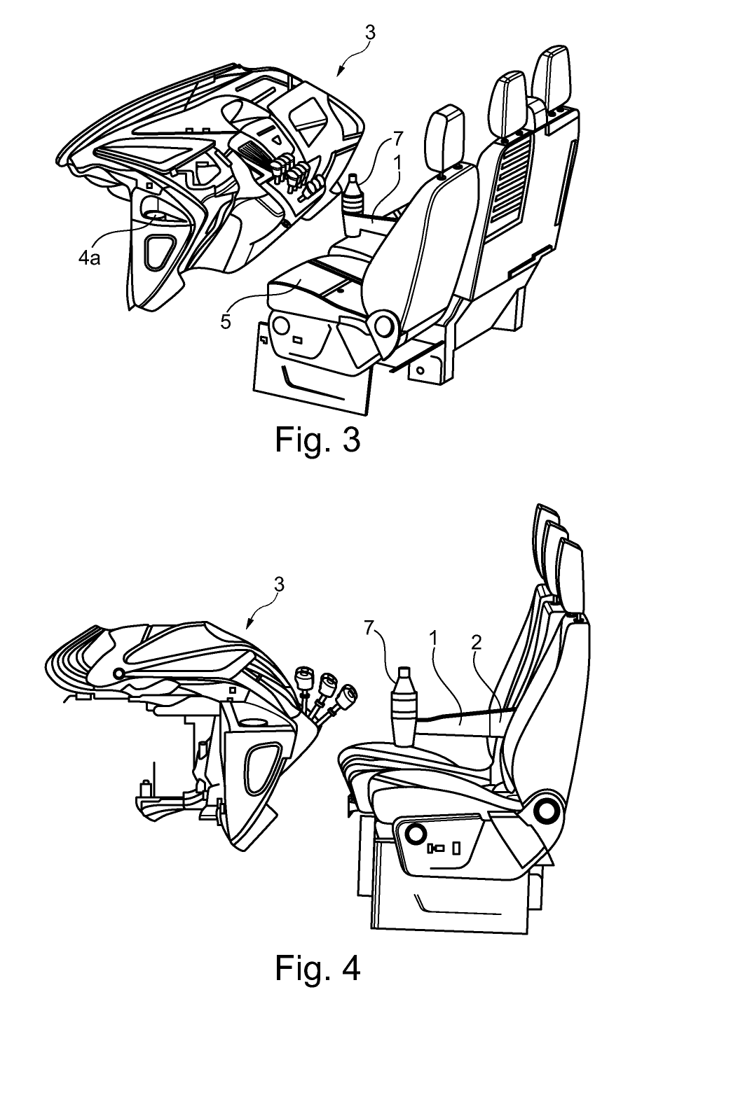

FIG. 3 is another 3D view on the vehicle of FIG. 1. In the example of FIG. 3, the cup holder holds a cup in the form of a bottle 7. FIG. 4, which is a side view of FIG. 3, clearly shows that the cup holder 1 is mounted to the armrest 2. It is preferred that the cup holder 1 does not extend beyond the driver's seat, but the skilled person can easily choose a suitable length such that the cup holder 1, or any bottle 7 placed therein does not hinder driving activities, such as,e.g., changing gears.

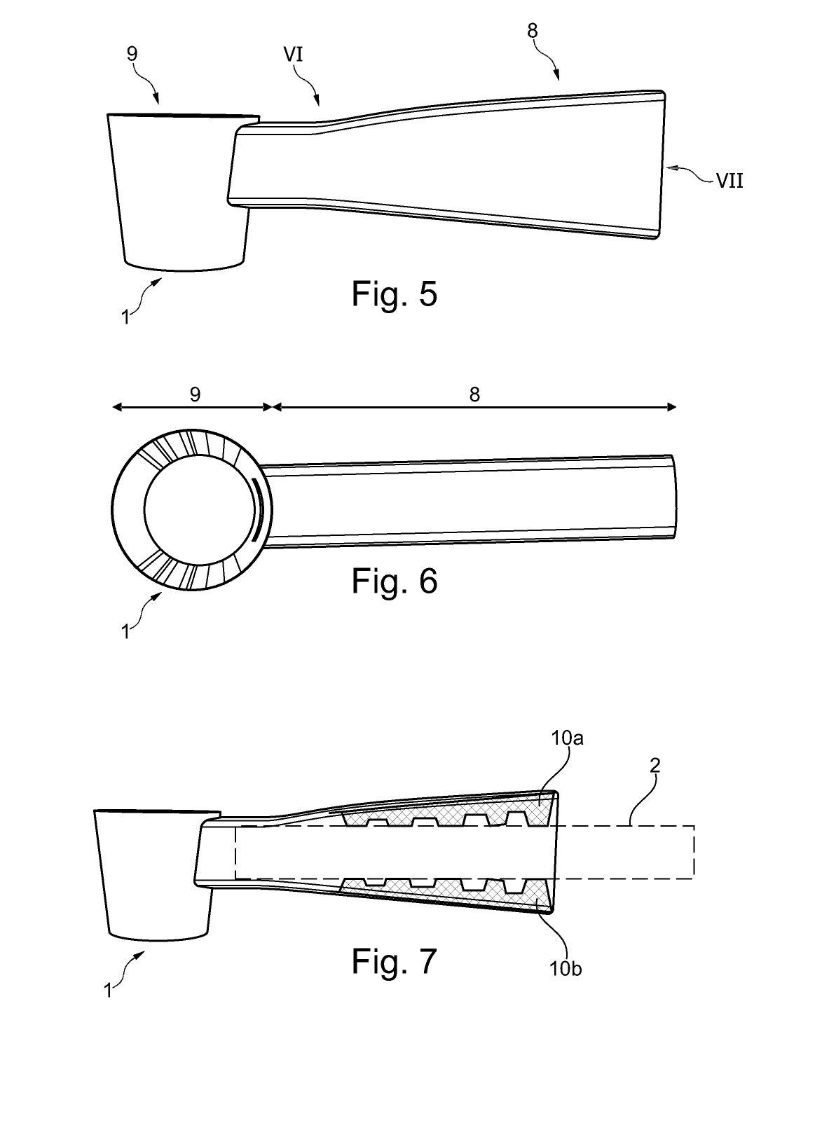

FIG. 5 and FIG. 6 show an exemplary embodiment of a cup holder 1, as seen from the outside. The cup holder 1 has an elongated tubular portion 8 (right of FIG. 5 and FIG. 6), and an end portion 9 for holding a cup (left of FIG. 5 and FIG. 6). FIG. 5 is a side view. FIG. 6 is a top view. The end portion 9 shown in FIG. 5 and FIG. 6 has a truncated conical shape with a closed bottom, but that is not absolutely required as other shapes may also be used.

The cup holder 1 can be releasably mounted and clamped to the armrest 2 in a clamping assembly in several ways, as will be illustrated in FIGS. 7-10.

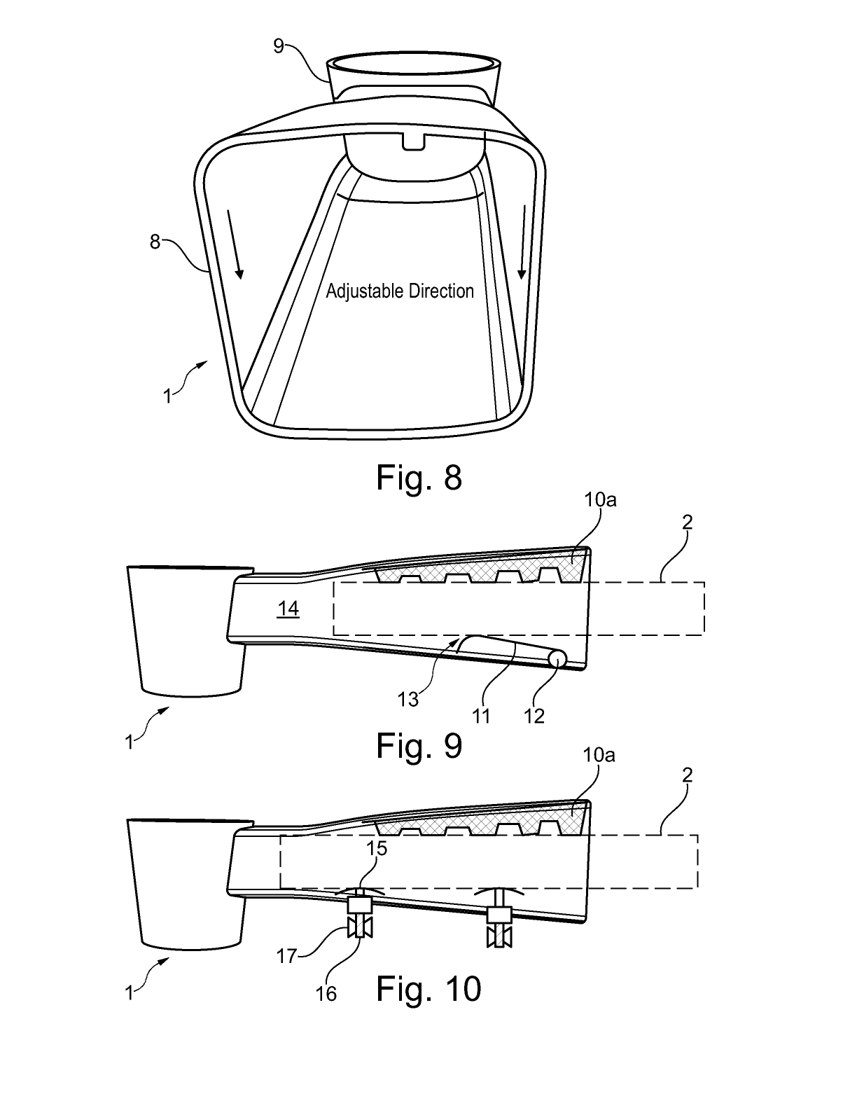

FIG. 7 is a cross-sectional view showing the cup holder 1 of FIG. 5 and FIG. 6 with a flexible, e.g., reversibly compressible and expandable material, e.g., a foam material, arranged against an inner wall (here the bottom wall and the top wall) of the elongated tubular portion 8 of the cup holder 1. The flexible material may have a first substantially planar surface which can be glued to an inner wall of the elongated portion 8 of the cup holder, and may have a second surface, opposite the first surface, having a non-planar shape, for example, having a corrugated or undulated shape, or a shape having a plurality of protrusions. The flexible material may be present on only two inner walls of the elongated tubular portion of the cup holder, e.g., only the upper and bottom inner walls but not the side walls, or on only three inner walls, or on all four inner walls. FIG. 8 is a rear view of the cup holder of FIG. 5 (looking inside the elongated tubular portion).

FIG. 9 is a variant of the embodiment of FIG. 7, comprising at least one movable element 11, e.g., a movable plate, operated by a spring 12, for clamping the armrest 2 to the upper wall of the elongated portion 8 of the cup holder. The movable element 11 may be formed integral with the spring 12. The movable element 11 may have a curved or bended end 13 for smooth contact with the armrest 2. In the example shown in FIG. 9, the elongated tubular portion also contains a flexible material 10a on the inner upper wall, but that is not absolutely required, and may be omitted.

In a variant of the embodiment shown in FIG. 9, the inner upper wall portion may have an additional movable element and an additional spring (not shown).

As can be appreciated by the skilled person, the cup holder 1 can be readily mounted to the armrest 2 by simply sliding the cup holder 1 on the armrest 2, such that at least a portion of the armrest 2 is inserted in the cavity 14 of the elongated tubular portion 8. The movable element 11 and the spring 12 are arranged such that the spring automatically pushes the movable element 11 against a side of the armrest 2, thereby clamping the armrest 2 so as to keep the cup holder 1 in position. The skilled person can easily find a suitable spring force by performing routine experiments.

FIG. 10 is another variant of the cup holder 1 shown in FIG. 7. This cup holder 1 comprises two movable plates 15 (but only one would also work), each movable by means of a bolt 16, for clamping the armrest 2. Preferably, the bolts have a butterfly tail 17, which has enlarged wings for leverage that allow the bolts 16 to be easily fastened or loosened without requiring special tools. The bolts 16 are preferably located on a bottom side of the elongated tubular portion 8 of the cup holder 1 for not hindering the driver or the passengers. In the example shown in FIG. 10, the elongated tubular portion 8 also contains a flexible material 10a on the inner upper wall, but that is not absolutely required, and may be omitted in some embodiments.

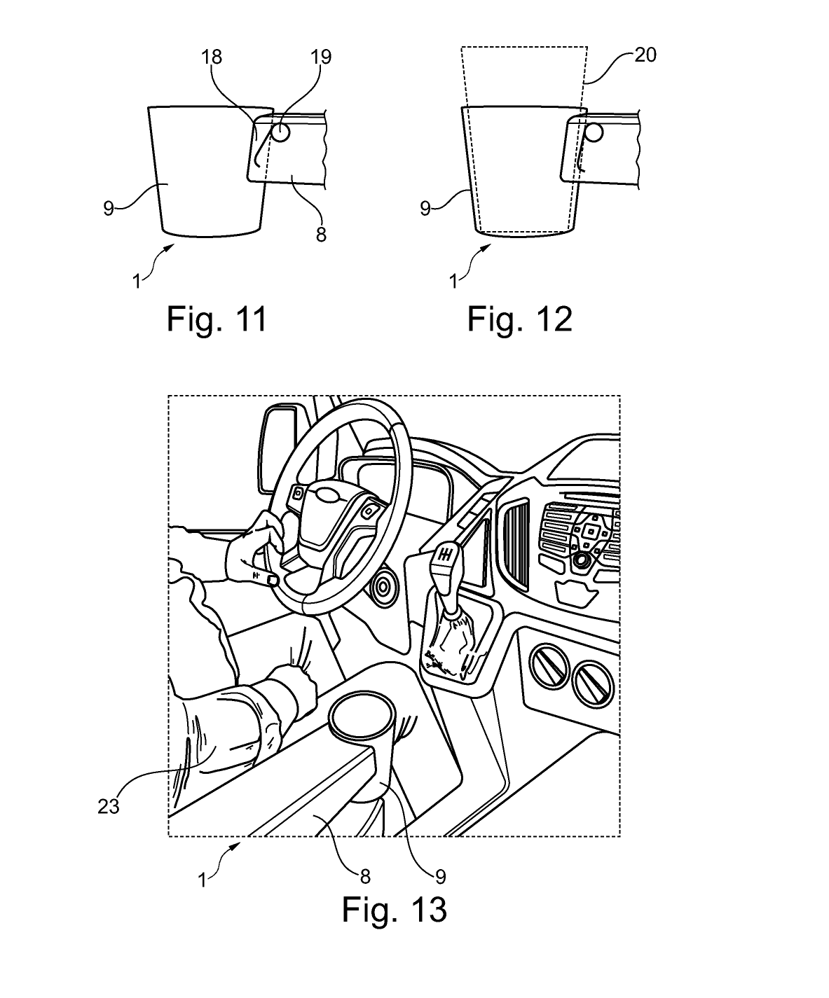

FIG. 11 and FIG. 12 show an example of a cup holder 1, where the end portion 9 has a truncated cone shape. Although not absolutely necessary for all embodiments, the end portion 9 has means for holding or clamping a cup 20. The cup 20 may be a 0.5 liter V cup shape. The dimensions of the end portion 9 may be specifically chosen such that at least 60% of the height of the cup 20 is contained within the space defined by the end portion 9. But of course the cup holder is not limited hereto, and other dimensions may also be chosen. The cup may also be described herein as a bottle or beverage container.

The means for holding or clamping the cup 20 may comprise a movable element 18 and a spring 19. This movable element 18 may have a bended or curved end for making smooth contact with the cup or bottle or metal can or other beverage container, and may be made of a metal, such as aluminium or stainless steel, or from a plastic material. The movable element 18 may be formed integral with the spring 19. The clamping force provided by the spring 19 can be much weaker than the clamping force provided by the spring 12. The skilled person can easily find a suitable spring force for envisioned cups including bottles and other similar shaped containers, by doing routine experiments. In FIG. 12 the movable element 18 is substantially flush with the inner wall of the truncated cone surface of the end portion 9.

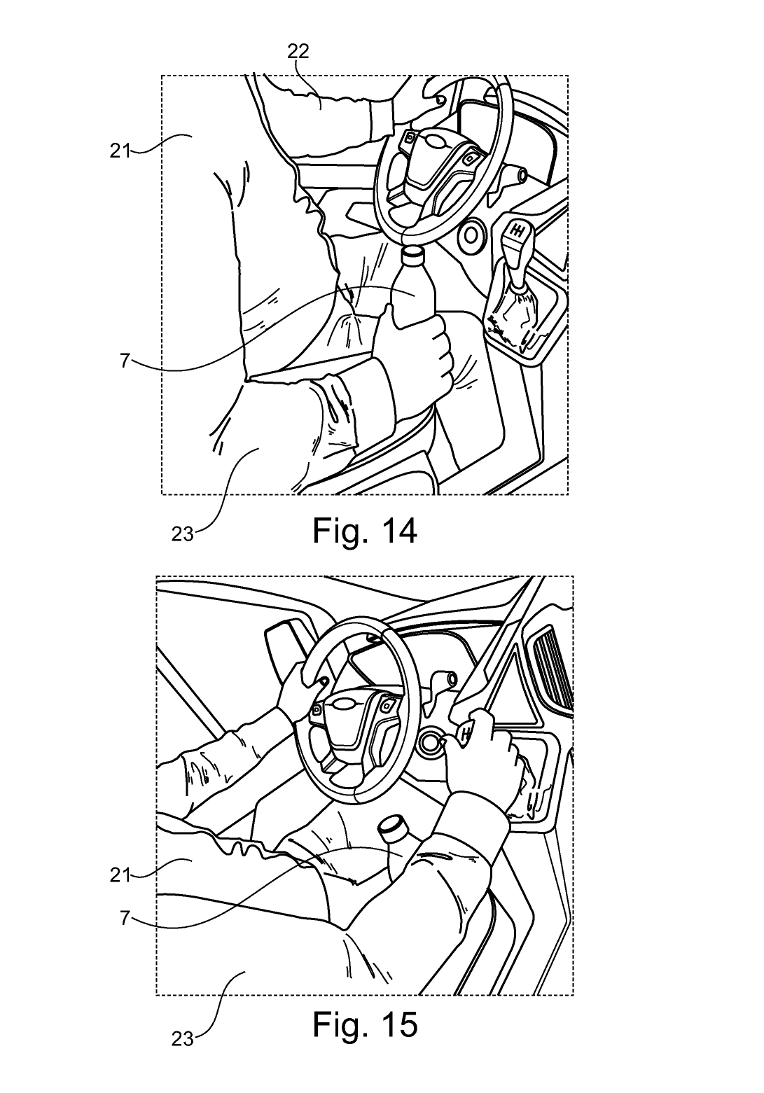

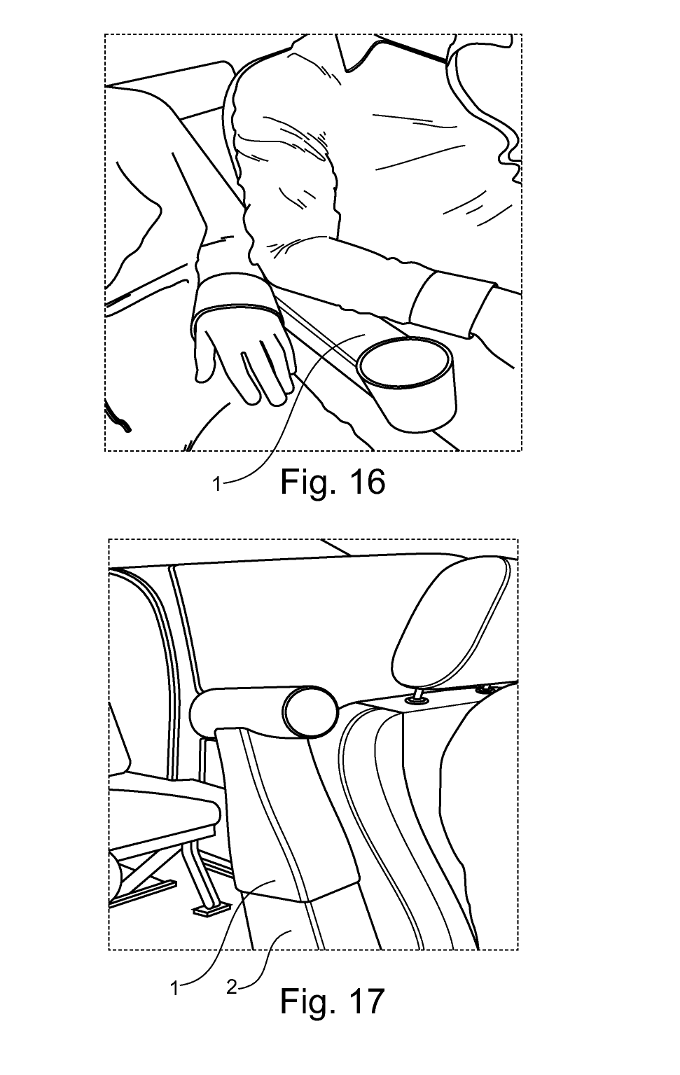

FIGS. 13-16 show the cup holder 1 mounted to an armrest 2 of a vehicle. In FIG. 13 the driver's right arm 23 is located next to the cup holder 1, and no cup or bottle or beverage container is present in the end portion 9 of the cup holder 1. In FIG. 14 the driver is taking a bottle 7 out of the end portion 9 of the cup holder 1, in a very convenient manner, while driving with his left arm 22. As can be seen, he barely has to move his right arm 23 to take the bottle 7 or to put it back, and he certainly does not have to cross his right arm 23 over his left arm 22, as would be needed if the bottle 7 were placed in the cup holder 4a of FIG. 2. Thus, mounting the cup holder 1 on the armrest 2 provides for comfortable and safe driving. As can be seen in FIG. 15, the driver 21 can easily switch gears with his right arm 23 without being hindered by the bottle 7 present in the cup holder 1. In FIG. 16 the driver's right elbow 24 is resting on the cup holder 1.

FIG. 17 shows the armrest 2 of the vehicle in an upright position, while the cup holder 1 is still mounted thereto. But of course, the cup holder 1 may be removed before the armrest 2 is moved to an upright position.

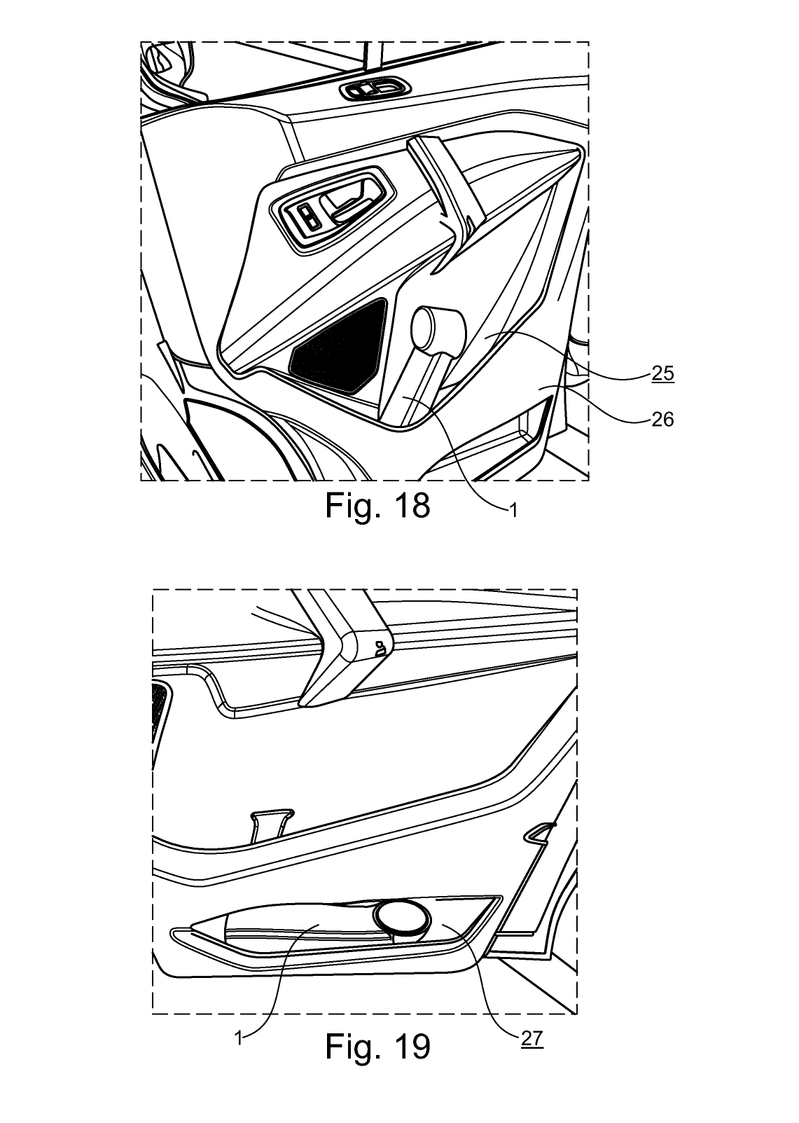

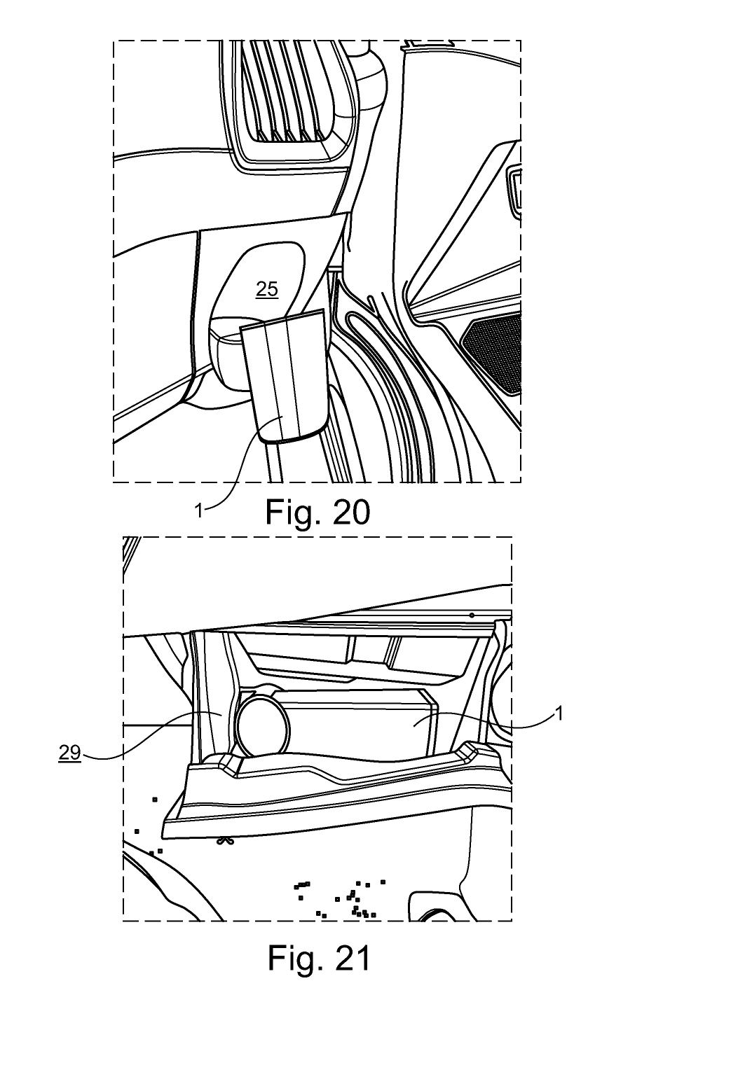

FIGS. 18-21 show several examples of where the cup holder 1 can be stowed after being removed from the armrest 2. In FIG. 18 the cup holder 1 is temporarily stowed in the upper compartment 25 of the right front door 26 of the vehicle. In FIG. 19 the cup holder 1 is stowed in the lower compartment 27 of the right front door 26. In FIG. 20 the elongated tubular portion 8 of the cup holder 1 is inserted in an elongated cavity 28 in the dashboard 3 of the vehicle. In FIG. 21 the cup holder is inserted in the glove compartment 29 of the dashboard 3 of the vehicle. It is evident that these are mere examples to demonstrate that the cup holder 1 can easily be stowed in one of the compartments available in a vehicle.

It should be noted that the individual features listed in the description below can be combined in any technically meaningful way with each other and show further embodiments of the cup holder.

According to the embodiments disclosed, a cup holder releasably mountable to an armrest of a vehicle is disclosed. The cup holder includes: an end portion having a shape for holding a cup or bottle or beverage container, and an elongated tubular portion having a first end connected to the end portion and a second end, opposite the first end, comprising an opening for receiving at least part of the armrest. The elongated tubular portion has means for releasably clamping the armrest when inserted in the opening, without damaging the armrest.

It is an advantage of such a cup holder that it can be mounted to or on an armrest, which is located directly adjacent the driver's seat, and hence it does not obstruct the view in the side mirrors and does not prevent good sight of the driver.

It is an advantage that the cup holder is releasably mountable to the armrest, so that it can be installed when desired (e.g., before starting a long trip), and removed when desired (e.g., when parked in a parking space). This also facilitates installation after production of the vehicle, as an add-on. The cup holder which allows easy access to the cup or bottle or beverage container, and requires only minimal movement and thus minimal distraction from the driver, thereby increasing safety and user convenience.

It is an advantage that the cup holder has a clamping assembly for clamping the armrest, so that the risk of the cup holder unintentionally being removed from the armrest is minimal, hence also the risk of spillage is reduced.

It is an advantage of using the clamping assembly that the inner dimensions (e.g., inner diameter or inner width and height) of the elongated tubular section need not be exactly matched with that of the armrest, but a relatively large tolerance margin (e.g., up to several cm) may be acceptable. Thus a single cup holder having particular dimensions may be suited for armrests of various dimensions.

According to an advantageous embodiment, the elongated tubular portion has a substantially rectangular cross section, optionally with rounded edges. A rectangular cross section, or any cross section with a substantially flat upper inner side, has the advantage (as compared to, e.g., a circular cross section) that the cup holder has a minimum risk of being inadvertently rotated, thus the risk of spillage is further reduced or eliminated.

According to a further advantageous embodiment, a cross-sectional area of the elongated tubular portion is substantially constant over at least 50% of the length of the elongated tubular portion, preferably over at least 70% of the length of the elongated tubular portion. A cup holder with a substantially constant cross section, especially when containing a compressible foamable material as a clamping mechanism, has the advantage that the clamping force exerted upon the armrest gradually increases (e.g., almost linearly) with the penetration depth of the armrest inside the elongated tubular portion, thus providing good clamping.

According to a further advantageous embodiment, a cross-sectional area of the elongated tubular portion is monotonically decreasing over at least 50% of the length of the elongated tubular portion, preferably over at least 70% of the length of the elongated tubular portion, in a direction towards the end portion.

It is an advantage of a cup hold with a decreasing cross-sectional area, e.g., having an elongated tubular section with a substantially conical shape, that it may be mounted on an even larger variety of armrests of various dimensions, because the difference between the inner dimensions of the cup holder and the outer dimensions of the armrest varies over the length of the cup holder, and at some point this will provide a relatively low clamping force, at another point a medium clamping force, and at yet another point a relatively large clamping force.

According to yet a further advantageous embodiment, the clamping assembly for releasably clamping the armrest comprises at least one first movable element and a first spring, the movable element preferably being pivotally connected to an inner wall of the elongated tubular portion, and being pushed away from the inner wall by means of the first spring. It is an advantage of using a spring and a pivotable element for clamping, because it can be produced relatively easily, and because it is highly reliable during actual use, with no significant wear. Preferably, the movable element is a polished slightly bended or rounded metal plate, e.g., made of aluminium or stainless steel, but a plastic material may also be used. Such a cup holder can be easily mounted on the armrest by “simply pushing” the cup holder over the armrest. The spring will automatically engage and exert a clamping force. Likewise, the cup holder can be very easily removed from the armrest by simply pulling the cup holder away from the armrest, and the spring will automatically disengage when the cup holder is removed from the armrest. The bended or rounded metal plate will not significantly damage or scratch the armrest.

According to a further advantageous embodiment, the clamping assembly for releasably clamping the armrest comprises a resilient material, e.g., a reversibly compressible and expandable foam material, loosely or fixedly arranged inside the interior of the elongated tubular portion, and adapted for being compressed when the armrest is inserted inside the tubular opening, thereby clamping the armrest. It is an advantage of using a resilient material, e.g., a reversibly compressible and expandable foamed material, preferably having a first, substantially planar surface for facing an inner wall of the elongated tubular portion, and a second, non-planar surface for facing the armrest, e.g., an undulating surface, or having a plurality of protrusions, because such a surface made of such a material also automatically provides a suitable clamping force when the armrest is inserted inside the hollow space of the elongated tubular portion. The more the resilient material, e.g., foam is compressed, the higher the clamping force. By providing a second, non-planar surface, the foam can expand laterally when being compressed. By choosing an appropriate shape for the second surface of the resilient material, e.g., a shape having a sinusoidal or triangular or trapezoidal shape, a suitable clamping force can be provided, allowing for easy insertion and removal, yet providing a good mounting with a minimum risk of inadvertent loosening of the cup holder.

The resilient material may, for example, be loosely applied inside the elongated tubular portion, and may have the shape of a sleeve which may be inserted inside the tubular portion before being pushed over the armrest. Alternatively the sleeve may be “wrapped over” the armrest before the cup holder is slid on the sleeve. Alternatively, the resilient material, e.g., the reversibly compressible and expandable foamed material, may be a layer which is fixed to an inner wall of the cup holder, e.g., glued thereto. As described above, preferably this layer has a second, non-planar inner surface, but, e.g., an undulated shape, or a shape with a plurality of protrusions. Gluing this layer to the inside of the cup holder may provide a better clamping, and reduce the risk of inadvertently removing the cup holder.

According to a further advantageous embodiment, the clamping assembly for releasably clamping the armrest comprises at least one clamping plate arranged inside the elongated tubular portion and being movable inwardly and outwardly by means of a bolt.

In this embodiment, the cup holder may be slid on the armrest in a first operation, and clamped thereto in a second operation. This offers the advantage that the clamping force is independent of the force required to push the cup holder over the armrest. In particular, the clamping force may be much higher than the force required to push or merely slide the cup holder on the armrest. In this way a very strong fixation can be provided, but only needs to be provided to the armrest when the cup holder is in its final position. It also allows a good clamping irrespective of the inner dimensions of the elongated tubular portion, and the outer dimensions of the armrest, which may be quite different. By using a clamping plate having a sufficiently large area, and preferably having a bended or rounded surface, and preferably made of metal, e.g., aluminium or stainless steel, the risk of damaging the armrest is minimized.

It is an advantage of locating the bolts on the bottom side of the cup holder, because in this position it will not hinder the driver or the passengers. According to a further advantageous embodiment, the bolt has a butterfly tail. It is an advantage in that this allows tight fastening of the bolts, without requiring any tools, which allows very convenient mounting/dismounting of the cup holder to/from the armrest.

According to a further advantageous embodiment, the end portion has an annular ring shape for receiving and holding the cup or bottle or beverage container. It is an advantage of using an annular ring shape (having a given diameter) in that it is very suitable for holding a cup with a conical shape, the latter having a non-constant diameter at different height positions of the cup. This has the advantage that the cup, when inserted in the annular ring, will automatically stop at a suitable position. It also allows the cup to be pushed upwards from below, if desired, for easy removal of the cup.

According to a further advantageous embodiment, the end portion has a cylindrical or truncated conical shape with a closed bottom, adapted for receiving the cup, including a bottle or beverage container. Using a cylindrical or truncated conical shape with a closed bottom offers many of the same advantages as an end portion with an annular ring shape, but has the additional advantage that the bottom is closed. This allows that also bottles or metal cans or other beverage containers with a cylindrical shape, or with a diameter smaller than the inner diameter of the cup holder, can be placed in the cup holder, and thus allows holding a much wider range of beverage containers.

According to a further advantageous embodiment, the end portion further comprises at least one second movable element for clamping said cup or bottle or beverage container, the second movable element being movable between a first position in which the movable element extends at least partially inside said annular ring or truncated conical shape, and a second position in which the second movable element is substantially flush with an inner wall of said annular ring or truncated conical shape, the second movable element being operated by a second spring adapted for clamping said cup or bottle or beverage container when at least partly inserted in said annular ring or truncated conical shape. Using a movable element and a spring in the end portion offers the advantage that the cup or bottle or metal can or the like can be clamped. This provides for stable positioning of the cup or bottle or the like, reducing the risk of spilling.

According to a further advantageous embodiment, the end portion has a size and shape sufficiently large for receiving a standard 33 cl metal beverage can over at least 60% of its height, preferably at least 70%. This is a convenient size. This size is also suitable for holding many types of small bottles. By providing a shape that contains at least 60% or at least 70% of the height of the standard can, the risk of inadvertently pushing the can out of the cup holder is drastically reduced or even minimal.

According to a further advantageous embodiment, the end portion has a size and shape sufficiently large for receiving a 0.5 litre V cup shape, and in case the end portion has a closed bottom, for receiving at least 60% of the height of said cup shape.

It will be understood that any described processes or steps within described processes may be combined with other disclosed processes or steps to form structures within the scope of the present invention. The exemplary structures and processes disclosed herein are for illustrative purposes and are not to be construed as limiting.

What is claimed is:

1. A cup holder releasably mountable to an armrest of a vehicle, comprising:
an end portion having a shape configured to hold a cup;
an elongated tubular portion having a first end connected to the end portion and a second end, opposite the first end, comprising an opening for receiving at least part of the armrest; and
a clamping assembly formed in the tubular portion for releasably clamping the armrest when inserted in the opening, without damaging the armrest.

2. The cup holder according to claim 1, wherein the elongated tubular portion has a substantially rectangular cross section, optionally with rounded edges.

3. The cup holder according to claim 1, wherein a cross-sectional area of the elongated tubular portion is substantially constant over at least 50% of the length of the elongated tubular portion.

4. The cup holder according to claim 1, wherein a cross-sectional area of the elongated tubular portion is substantially constant over at least 70% of the length of the elongated tubular portion.

5. The cup holder according to claim 1, wherein a cross-sectional area of the elongated tubular portion is monotonically decreasing over at least 50% of the length of the elongated tubular portion.

6. The cup holder according to claim 1, wherein a cross-sectional area of the elongated tubular portion is monotonically decreasing over at least 70% of the length of the elongated tubular portion, in a direction towards the end portion.

7. The cup holder according to claim 1, wherein the clamping assembly for releasably clamping the armrest comprises at least one first movable element and a first spring, the first movable element being pivotally connected to an inner wall of the elongated tubular portion, and being pushed away from the inner wall by means of the first spring.

8. The cup holder according to claim 1, wherein the clamping assembly for releasably clamping the armrest comprises a resilient material, e.g. a compressible and expandable foam material, loosely or fixedly arranged inside the interior of the elongated tubular portion, and adapted for being compressed when the armrest is inserted inside the opening, thereby clamping the armrest.

9. The cup holder according to claim 1, wherein the clamping assembly for releasably clamping the armrest comprises at least one clamping plate arranged inside the elongated tubular portion and movable inwardly and outwardly by means of a bolt.

10. The cup holder according to claim 7, wherein the bolt has a butterfly tail.

11. The cup holder according to claim 1, wherein the end portion has an annular ring shape for receiving and holding said cup.

12. The cup holder according to claim 1, wherein the end portion has a cylindrical or truncated conical shape with a closed bottom for receiving said cup.

13. The cup holder according to claim 1, wherein the end portion further comprises at least one second movable element for clamping said cup, the second movable element being movable between a first position in which the second movable element extends at least partially inside said annular ring or truncated conical shape, and a second position in which the second movable element is substantially flush with an inner wall of said annular ring or truncated conical shape, the second movable element being operated by a second spring adapted for clamping said cup when at least partly inserted in said annular ring or truncated conical shape.

14. The cup holder according to claim 1, wherein the end portion has a size and shape sufficiently large for receiving a standard 33 cl metal beverage can over at least 60% of its height.

15. The cup holder according to claim 1, wherein the end portion has a size and shape sufficiently large for receiving a 0.5 litre V cup shape, and in case the end portion (9) has a closed bottom, for receiving at least 60% of the height of said cup shape.

16. A cup holder releasably mountable to an armrest of a vehicle, comprising:
an end portion having a shape configured to hold a cup;
an elongated tubular portion having a first end connected to the end portion and an opposite second end comprising an opening for receiving at least part of the armrest; and
a clamping assembly for releasably clamping the armrest when inserted in the opening.

17. The cup holder according to claim 16, wherein the clamping assembly for releasably clamping the armrest comprises at least one first movable element and a first spring, the first movable element being pivotally connected to an inner wall of the elongated tubular portion, and being pushed away from the inner wall by means of the first spring.

18. The cup holder according to claim 16, wherein the clamping assembly for releasably clamping the armrest comprises a resilient material, e.g., a compressible and expandable foam material, loosely or fixedly arranged inside the interior of the elongated tubular portion, and adapted for being compressed when the armrest is inserted inside the opening, thereby clamping the armrest.

19. The cup holder according to claim 16, wherein the clamping assembly for releasably clamping the armrest comprises at least one clamping plate arranged inside the elongated tubular portion and movable inwardly and outwardly by means of a bolt.

20. The cup holder according to claim 16, wherein the elongated tubular portion has a substantially rectangular cross section, optionally with rounded edges.
